(19) United States
(12) Patent Application Publication
(10) Pub. No.: US 2020/0272177 A1
(43) Pub. Date: Aug. 27, 2020

(54) MAINTENANCE FEE PAYMENT METHOD BASED ON COMPOUND INTERNET OF THINGS (IOT) AND IOT SYSTEM

(71) Applicant: Chengdu Qinchuan Technology Development Co., Ltd., Changdu (CN)

(72) Inventor: Zehua SHAO, Chengdu (CN)

(21) Appl. No.: 16/287,898

(22) Filed: Feb. 27, 2019

(51) Int. Cl. G05D 7/06; G06Q 10/00; G06Q 20/14; G06Q 50/06; G05B 15/02

(52) U.S. Cl. CPC G05D 7/0635; G06Q 10/20; G05B 15/02; G06Q 50/06; G06Q 20/14

(57) ABSTRACT

The present invention relates to the field of an Internet of Things (IoT), and provides a maintenance fee payment method based on a compound IoT and an IoT system. According to the maintenance fee payment method based on the compound IoT provided by the present invention, maintenance fee for a gas pipeline and a gas meter may be paid on the Internet; during payment, a management sub-platform further sends a detection instruction to the gas meter; and after the gas meter detects that a fault is solved, the management sub-platform charges a maintenance amount; and therefore, the problem of inconvenient payment is solved.

### TECHNICAL FIELD

The present invention relates to the field of an Internet of Things (IoT), in particular to a maintenance fee payment method based on a compound IoT and an IoT system.

### BACKGROUND

Along with ever-changing development of an IoT technology, various instruments and meters, such as a gas meter, also enter the sector of an IoT. A traditional gas meter has been gradually replaced by an IoT intelligent gas meter. After a gas pipeline or a gas meter of a user is faulty, the user needs to make a telephone call to a natural gas company to find a maintenance staff for maintenance. A technician comes to maintain the gas meter or the gas pipeline. Generally, after the maintenance, the maintenance staff fills out a bill of payment and the user needs to come to the natural gas company for fee payment, so that the time cost and labor cost are wasted.

### SUMMARY OF THE INVENTION

In view of this, an objective of the present invention is to provide a maintenance fee payment method based on a compound IoT and an IoT system to solve the problem of inconvenient payment after a pipeline or a gas meter is maintained.

To this end, the technical solutions adopted by the present invention are as follows:

According to a first aspect, the present invention provides a maintenance fee payment method based on a compound IoT. The method is applied to an IoT system; the IoT system includes a plurality of user sub-platforms, a plurality of service sub-platforms, a plurality of management sub-platforms, a sensor network platform and a plurality of object sub-platforms; the plurality of management sub-platforms include a plurality of management servers of a gas company; each of the plurality of object sub-platforms includes a gas meter; and the method includes: sending, by a user sub-platform, maintenance data information to one of the plurality of management sub-platforms via one of the plurality of service sub-platforms; sending, by the management sub-platform that receives the maintenance data information, a detection instruction to a corresponding gas meter via the sensor network platform according to the maintenance data information; detecting, by the gas meter, whether a fault is solved or not according to the detection instruction; sending, when the gas meter detects that the fault is solved, a confirmation instruction to the management sub-platform via the sensor network platform; deducting, by the management sub-platform, a maintenance amount corresponding to the maintenance data information from the user sub-platform according to the confirmation instruction, and sending fee payment success notification to the user sub-platform via one of the plurality of service sub-platforms; and controlling, by the management sub-platform, the gas meter via the sensor network platform to open a valve.

Further, the maintenance data information includes: the maintenance amount, a maintenance order number, a maintenance staff number and a gas meter Identification (ID) number.

Further, the method further includes: sending, by the user sub-platform, material parameters input by a user to the management sub-platform via one of the plurality of service sub-platforms, where the material parameters include a pipeline category, a pipeline length and a gas meter model; and generating, by the management sub-platform, the maintenance amount according to the material parameters and maintenance time.

Further, the plurality of service sub-platforms include an operator service platform and a recharge platform; and the method specifically further includes: deducting, by the management sub-platform, the maintenance amount corresponding to the maintenance data information from the recharge platform according to the confirmation instruction, and deducting, by the recharge platform, the maintenance amount from an account corresponding to the user sub-platform; and sending, by the management sub-platform, the fee payment success notification to the user sub-platform via the operator service platform.

Further, the maintenance data information includes the maintenance staff number; and the method further includes: recording, by the management sub-platform, the maintenance staff number when receiving the maintenance data information at each time; sending, by the management sub-platform, if the platform judges that a same maintenance staff number appears at different places at the same time, a maintenance staff photo via one of the plurality of service sub-platforms to the user sub-platform that sends the maintenance data information; and feeding, by the user sub-platform, a verification condition of the user back to the management sub-platform.

According to a second aspect, the present invention further provides an IoT system, which includes a plurality of user sub-platforms, a plurality of service sub-platforms, a plurality of management sub-platforms, a sensor network platform and a plurality of object sub-platforms; the plurality of management sub-platforms include a plurality of management servers of a gas company; each of the plurality of object sub-platforms includes a gas meter; each of the user sub-platforms is configured to send maintenance data information to one of the plurality of management sub-platforms via one of the plurality of service sub-platforms; the management sub-platform is configured to send a detection instruction to a corresponding gas meter via the sensor network platform according to the maintenance data information; the gas meter is configured to detect whether a fault is solved or not according to the detection instruction, and send, when detecting that the fault is solved, a confirmation instruction to the management sub-platform via the sensor network platform; and the management sub-platform is further configured to deduct a maintenance amount corresponding to the maintenance data information from the user sub-platform according to the confirmation instruction, send fee payment success notification to the user sub-platform via one of the plurality of service sub-platforms, and control the gas meter via the sensor network platform to open a valve.

Further, the maintenance data information includes: the maintenance amount, a maintenance order number, a maintenance staff number and a gas meter ID number.

Further, the user sub-platform is further configured to send material parameters input by a user to the management sub-platform via one of the plurality of service sub-platforms, where the material parameters include a pipeline category, a pipeline length and a gas meter model; and the management sub-platform is further configured to generate the maintenance amount according to the material parameters and maintenance time.

Further, the plurality of service sub-platforms include an operator service platform and a recharge platform; the management sub-platform is further configured to deduct the maintenance amount corresponding to the maintenance data information from the recharge platform according to the confirmation instruction, and the recharge platform deducts the maintenance amount from an account corresponding to the user sub-platform; and the management sub-platform is further configured to send the fee payment success notification to the user sub-platform via the operator service platform.

Further, the maintenance data information includes the maintenance staff number; and the management sub-platform is further configured to: record the maintenance staff number when receiving the maintenance data information at each time, and send, if the management sub-platform judges that a same maintenance staff number appears at different places at the same time, a maintenance staff photo via one of the plurality of service sub-platforms to the user sub-platform that sends the maintenance data information; and the user sub-platform is further configured to feed a verification condition of the user back to the management sub-platform.

The present invention provides a maintenance fee payment method based on a compound IoT and an IoT system. The method is applied to the IoT system; the IoT system includes a plurality of user sub-platforms, a plurality of service sub-platforms, a plurality of management sub-platforms, a sensor network platform and a plurality of object sub-platforms; the plurality of management sub-platforms include a plurality of management servers of a gas company; each of the plurality of object sub-platforms includes a gas meter; and the method includes: sending, by a user sub-platform, maintenance data information to one of the plurality of management sub-platforms via one of the plurality of service sub-platforms; sending, by the management sub-platform that receives the maintenance data information, a detection instruction to a corresponding gas meter via the sensor network platform according to the maintenance data information; detecting, by the gas meter, whether a fault is solved or not according to the detection instruction; sending, when the gas meter detects that the fault is solved, a confirmation instruction to the management sub-platform via the sensor network platform; deducting, by the management sub-platform, a maintenance amount corresponding to the maintenance data information from the user sub-platform according to the confirmation instruction, and sending fee payment success notification to the user sub-platform via one of the plurality of service sub-platforms; and controlling, by the management sub-platform, the gas meter via the sensor network platform to open a valve. According to the maintenance fee payment method based on the compound IoT provided by the present invention, maintenance fee for a gas pipeline and a gas meter may be paid on the Internet; during payment, a management sub-platform further sends a detection instruction to the gas meter; and after the gas meter detects that a fault is solved, the management sub-platform charges a maintenance amount; and therefore, the problem of inconvenient payment is solved.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention;

FIG. 2 illustrates a flowchart of a maintenance fee payment method based on a compound IoT provided by an embodiment of the present invention; and

FIG. 3 illustrates a schematic diagram of an application scenario of a maintenance fee payment method based on a compound IoT provided by an embodiment of the present invention.

Numerals in the drawings: 100—IoT system; 10—user sub-platform; 20—service sub-platform; 30—management sub-platform; 40—sensor network platform; 50—object sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

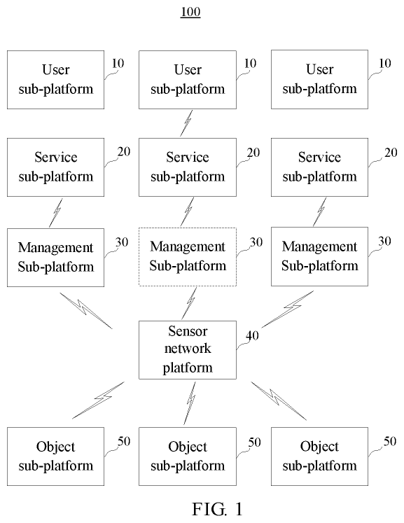

Referring to FIG. 1, a compositional schematic diagram of an IoT system provided by an embodiment of the present invention. A maintenance fee payment method based on a compound IoT provided by an embodiment of the present invention is applied to an IoT system 100. The IoT system 100 includes a plurality of user sub-platforms 10, a plurality of service sub-platforms 20, a plurality of management sub-platforms 30, a sensor network platform 40 and a plurality of object sub-platforms 50. Herein, any one of the plurality of object sub-platforms 50 may be communicatively connected with any one of the plurality of management sub-platforms 30 via the sensor network platform 40.

Any one of the plurality of management sub-platforms 30 is communicatively connected with the plurality of service sub-platforms 20. In this embodiment, the service sub-platforms 20 may include an operator service platform and a recharge platform. The plurality of service sub-platforms 20 are communicatively connected with each of the user sub-platforms 10, and are configured to receive maintenance data information sent by each of the user sub-platforms 10, send fee payment success notification to each of the user sub-platforms 10, etc.

The user sub-platforms 10 each may be a universal electronic device, such as a Personal Computer (PC), an intelligent mobile phone, a tablet computer, a Personal Digital Assistant (PDA), and a Mobile Internet Device (MID). In this embodiment, the user sub-platforms 10 are intelligent mobile phones, each of which may send a plurality of instructions to the service sub-platforms 20 via an Application (APP). The plurality of management sub-platforms 30 may be a plurality of management servers of a gas company. Each of the object sub-platforms 50 is a gas meter. The maintenance fee payment method based on the compound IoT provided by the embodiment of the present invention is applied to the plurality of user sub-platforms 10 to make a payment for maintenance fees of corresponding gas meters in a manner of Internet fee payment; and therefore, the maintenance fee payment method is convenient and simple, saves the labor cost and the time cost, and is also easy for management.

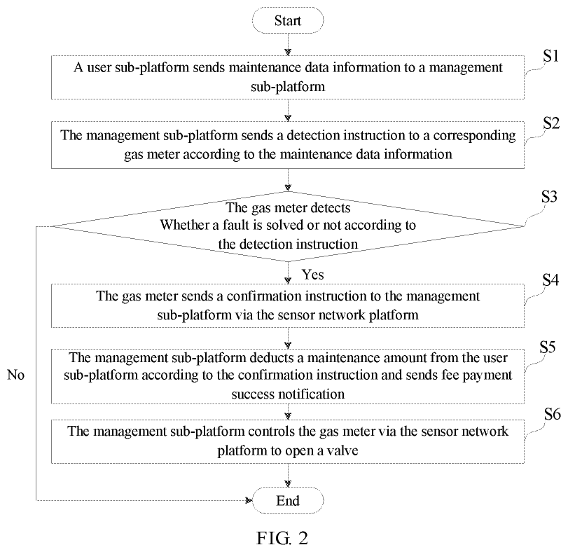

Referring to FIG. 2, a flowchart of a maintenance fee payment method based on a compound IoT provided by an embodiment of the present invention. It is to be noted that the maintenance fee payment method based on the compound IoT provided by the present invention is not limited to FIG. 2 and the following specific sequence. It should be understood that in other embodiments, sequences of a part of steps in the maintenance fee payment method based on the compound IoT provided by the present invention may be exchanged mutually based on actual requirements, or a part of steps may also be omitted or deleted. The maintenance fee payment method based on the compound IoT is applied to an IoT system 100, and the method includes the following steps.

Step S1, a user sub-platform sends maintenance data information to a management sub-platform 30.

The user sub-platform 10 sends the maintenance data information to one of the plurality of management sub-platforms 30 via one of the plurality of service sub-platforms 20. After a gas meter or a gas pipeline of a user is maintained by a maintenance staff, the user may send the maintenance data information to the management sub-platform 30 via an APP of a mobile phone, where an account corresponding to the APP matches with one of the plurality of management sub-platforms 30. In this embodiment, the maintenance data information includes: the maintenance amount, a maintenance order number, a maintenance staff number and a gas meter ID number. The maintenance amount and the maintenance order number are input to the mobile phone via a manual or voice manner of the user. The gas meter ID number may be associated with the account corresponding to the APP in advance. The maintenance staff number may be associated with the maintenance order number, e.g., a bill of payment dispatched by a gas company to each maintenance staff is provided with a unique maintenance order number. The management sub-platform 30 may directly invoke the maintenance staff number via the maintenance order number.

Step S2, the management sub-platform 30 sends a detection instruction to a corresponding gas meter according to the maintenance data information.

The management sub-platform 30 that receives the maintenance data information sends the detection instruction to the corresponding gas meter via the sensor network platform 40 according to the maintenance data information. The sensor network platform 40 may be an IoT intelligent gateway. Since one of the plurality of management sub-platforms 30 has received the maintenance data information, the management sub-platform 30 that receives the maintenance data information may send the detection instruction to the gas meter corresponding to the gas meter ID number in the maintenance data information so as to judge whether a fault is solved or not after maintenance.

Step S3, the gas meter detects whether a fault is solved or not according to the detection instruction.

If the gas meter detects that the fault is not solved, an unsolved instruction is sent to the corresponding management sub-platform 30, the management sub-platform 30 sends a message corresponding to the unsolved instruction to the user sub-platform 10 via an operator service platform, the management sub-platform 30 does not charge a fee, and the user may allow the maintenance staff to maintain continuously; and if the gas meter detects that the fault is solved, a step S4 is executed.

Step S4, the gas meter sends a confirmation instruction to the management sub-platform 30 via the sensor network platform 40.

When the gas meter detects that the fault is solved, the gas meter sends the confirmation instruction to the management sub-platform 30 via the sensor network platform 40.

Step S5, the management sub-platform 30 deducts a maintenance amount from the user sub-platform 10 according to the confirmation instruction and sends fee payment success notification.

The management sub-platform 30 deducts the maintenance amount corresponding to the maintenance data information from the user sub-platform 10 according to the confirmation instruction, and sends the fee payment success notification to the user sub-platform 10 via one of the plurality of service sub-platforms 20.

Specifically, the management sub-platform 30 deducts the maintenance amount corresponding to the maintenance data information from a recharge platform according to the confirmation instruction, and the recharge platform deducts the maintenance amount from an account corresponding to the user sub-platform 10. The recharge platform may be a server for recharging, such as a recharge server from Hongqi Chain Co., Ltd., WeChat and Alipay. The management sub-platform 30 sends the fee payment success notification to the user sub-platform 10 via the operator service platform.

Step S6, the management sub-platform 30 controls the gas meter via the sensor network platform 40 to open a valve.

After the management sub-platform 30 receives the confirmation instruction, i.e., the fault of the gas meter or the gas pipeline has been rectified, the gas meter is controlled via the sensor network platform 40 to open a master valve. It is to be noted that the step S5 and the step S6 are executed in a random sequence, and in other specific embodiments, the step S6 may be executed first or the step S5 and the step S6 are executed simultaneously.

In this embodiment of the present invention, the maintenance fee payment method based on the compound IoT further includes: the management sub-platform 30 records the maintenance staff number when receiving the maintenance data information at each time; if the management sub-platform 30 judges that a same maintenance staff number appears at different places at the same time, a maintenance staff photo is sent via one of the plurality of service sub-platforms 20 to the user sub-platform 10 that sends the maintenance data information; and the user sub-platform 10 feeds a verification condition of the user back to the management sub-platform 30.

Specifically, it may be appropriate that time within half an hour and an hour is the same time. For example, within half an hour, if the management sub-platform 30 makes a statistics of a same maintenance staff number for two pieces of maintenance data information, and positions where gas meter ID numbers corresponding to the two pieces of maintenance data information are located are not the same, the management sub-platform 30 preliminarily judges that a “worker replacement” phenomenon exists in two maintenance events, i.e., a person carries out maintenance via a number of another maintenance staff, which does not meet a system of the gas company, etc. In this case, it is necessary for the user to make a further confirmation.

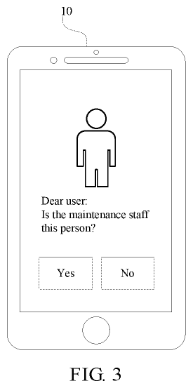

Referring to FIG. 3, a schematic diagram of an application scenario of a maintenance fee payment method based on a compound IoT provided by an embodiment of the present invention. When the management sub-platform 30 preliminarily judges that the “worker replacement” phenomenon exists, the maintenance staff photo is sent via one of the plurality of service sub-platforms 20 to the user sub-platform 10 that sends the maintenance data information, i.e., the maintenance staff photo is sent to the mobile phone of the user, the user compares the photo with the maintenance staff, and judges whether or not the maintenance staff is the person on the photo; and when the user taps “no”, the management sub-platform 30 will make a record.

In other specific embodiments, the maintenance amount may further be acquired via other manners. For example, the user may input material parameters via the mobile phone, the mobile phone sends the material parameters to the management sub-platform 30 via one of the plurality of service sub-platforms 20, and the management sub-platform 30 generates the maintenance amount according to the material parameters and maintenance time, where the material parameters include a pipeline category, a pipeline length and a gas meter model.

In conclusion, the present invention provides a maintenance fee payment method based on a compound IoT and an IoT system. The method is applied to the IoT system; the IoT system includes a plurality of user sub-platforms, a plurality of service sub-platforms, a plurality of management sub-platforms, a sensor network platform and a plurality of object sub-platforms; the plurality of management sub-platforms include a plurality of management servers of a gas company; each of the plurality of object sub-platforms includes a gas meter; and the method includes: a user sub-platform sends maintenance data information to one of the plurality of management sub-platforms via one of the plurality of service sub-platforms; the management sub-platform that receives the maintenance data information sends a detection instruction to a corresponding gas meter via the sensor network platform according to the maintenance data information; the gas meter detects whether a fault is solved or not according to the detection instruction; when the gas meter detects that the fault is solved, a confirmation instruction is sent to the management sub-platform via the sensor network platform; the management sub-platform deducts a maintenance amount corresponding to the maintenance data information from the user sub-platform according to the confirmation instruction, and sends fee payment success notification to the user sub-platform via one of the plurality of service sub-platforms; and the management sub-platform controls the gas meter via the sensor network platform to open a valve. According to the maintenance fee payment method based on the compound IoT provided by the present invention, maintenance fee for a gas pipeline and a gas meter may be paid on the Internet; during payment, a management sub-platform further sends a detection instruction to the gas meter; and after the gas meter detects that a fault is solved, the management sub-platform charges a maintenance amount; and therefore, the problem of inconvenient payment is solved. With the IoT system provided by the present invention, the “worker replacement” phenomenon of the maintenance staff may further be solved, thereby being convenient for the gas company to manage.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

What is claimed is:

1. A maintenance fee payment method based on a compound Internet of Things (IoT), wherein the method is applied to an IoT system; the IoT system comprises a plurality of user sub-platforms, a plurality of service sub-platforms, a plurality of management sub-platforms, a sensor network platform and a plurality of object sub-platforms; the plurality of management sub-platforms comprise a plurality of management servers of a gas company; each of the plurality of object sub-platforms comprises a gas meter; and the method comprises:
sending, by a user sub-platform, maintenance data information to one of the plurality of management sub-platforms via one of the plurality of service sub-platforms;
sending, by the management sub-platform that receives the maintenance data information, a detection instruction to a corresponding gas meter via the sensor network platform according to the maintenance data information;
detecting, by the gas meter, whether a fault is solved or not according to the detection instruction;
sending, by the gas meter, upon detecting that the fault is solved, a confirmation instruction to the management sub-platform via the sensor network platform;
deducting, by the management sub-platform, a maintenance amount corresponding to the maintenance data information from the user sub-platform according to the confirmation instruction, and sending fee payment success notification to the user sub-platform via one of the plurality of service sub-platforms; and
controlling, by the management sub-platform, the gas meter via the sensor network platform to open a valve.

2. The maintenance fee payment method based on the compound IoT according to claim 1, wherein the maintenance data information comprises: the maintenance amount, a maintenance order number, a maintenance staff number and a gas meter Identification (ID) number.

3. The maintenance fee payment method based on the compound IoT according to claim 1, wherein the method further comprises:
sending, by the user sub-platform, material parameters input by a user to the management sub-platform via one of the plurality of service sub-platforms, wherein the material parameters comprise a pipeline category, a pipeline length and a gas meter model; and
generating, by the management sub-platform, the maintenance amount according to the material parameters and maintenance time.

4. The maintenance fee payment method based on the compound IoT according to claim 1, wherein the plurality of service sub-platforms comprise an operator service platform and a recharge platform; and the method specifically further comprises:
deducting, by the management sub-platform, the maintenance amount corresponding to the maintenance data information from the recharge platform according to the confirmation instruction, and deducting, by the recharge platform, the maintenance amount from an account corresponding to the user sub-platform; and
sending, by the management sub-platform, the fee payment success notification to the user sub-platform via the operator service platform.

5. The maintenance fee payment method based on the compound IoT according to claim 1, wherein the maintenance data information comprises the maintenance staff number; and the method further comprises:
recording, by the management sub-platform, the maintenance staff number when receiving the maintenance data information at each time;
sending, by the management sub-platform, if the platform judges that a same maintenance staff number appears at different places at the same time, a maintenance staff photo via one of the plurality of service sub-platforms to the user sub-platform that sends the maintenance data information; and
feeding, by the user sub-platform, a verification condition of the user back to the management sub-platform.

6. An Internet of Things (IoT) system, comprising a plurality of user sub-platforms, a plurality of service sub-platforms, a plurality of management sub-platforms, a sensor network platform and a plurality of object sub-platforms, wherein the plurality of management sub-platforms comprise a plurality of management servers of a gas company; and each of the plurality of object sub-platforms comprises a gas meter;
each of the user sub-platforms is configured to send maintenance data information to one of the plurality of management sub-platforms via one of the plurality of service sub-platforms;
the management sub-platform is configured to send a detection instruction to a corresponding gas meter via the sensor network platform according to the maintenance data information;
the gas meter is configured to detect whether a fault is solved or not according to the detection instruction, and send, when detecting that the fault is solved, a confirmation instruction to the management sub-platform via the sensor network platform; and
the management sub-platform is further configured to deduct a maintenance amount corresponding to the maintenance data information from the user sub-platform according to the confirmation instruction, send fee payment success notification to the user sub-platform via one of the plurality of service sub-platforms, and control the gas meter via the sensor network platform to open a valve.

7. The IoT system according to claim 6, wherein the maintenance data information comprises: the maintenance amount, a maintenance order number, a maintenance staff number and a gas meter Identification (ID) number.

8. The IoT system according to claim 6, wherein the user sub-platform is further configured to send material parameters input by a user to the management sub-platform via one of the plurality of service sub-platforms, wherein the material parameters comprise a pipeline category, a pipeline length and a gas meter model; and
the management sub-platform is further configured to generate the maintenance amount according to the material parameters and maintenance time.

9. The IoT system according to claim 6, wherein the plurality of service sub-platforms comprise an operator service platform and a recharge platform; the management sub-platform is further configured to deduct the maintenance amount corresponding to the maintenance data information from the recharge platform according to the confirmation instruction, and the recharge platform deducts the maintenance amount from an account corresponding to the user sub-platform; and
the management sub-platform is further configured to send the fee payment success notification to the user sub-platform via the operator service platform.

10. The IoT system according to claim 6, wherein the maintenance data information comprises the maintenance staff number; and the management sub-platform is further configured to: record the maintenance staff number when receiving the maintenance data information at each time, and send, if the management sub-platform judges that a same maintenance staff number appears at different places at the same time, a maintenance staff photo via one of the plurality of service sub-platforms to the user sub-platform that sends the maintenance data information; and the user sub-platform is further configured to feed a verification condition of the user back to the management sub-platform.
